(19) United States
(12) Patent Application Publication
(10) Pub. No.: US 2025/0217387 A1
(43) Pub. Date: Jul. 3, 2025

(54) SYSTEMS AND METHODS FOR DATA STRUCTURE GENERATION TO DETERMINE A COMPATIBILITY DATUM

(71) Applicant: The Strategic Coach Inc., Toronto (CA)

(72) Inventors: Barbara Sue Smith, Toronto (CA); Daniel J. Sullivan, Toronto (CA)

(73) Assignee: The Strategic Coach Inc., Toronto (CA)

(21) Appl. No.: 18/402,459

(22) Filed: Jan. 2, 2024

(51) Int. Cl. G06F 16/28

(52) U.S. Cl. CPC G06F 16/285

(57) ABSTRACT

Disclosed herein is an apparatus and method for data structure generation. Apparatus may determine a high target convergence attribute pattern and use it, along with first system data to calculate first system target convergence. Apparatus may determine one or more advantage clusters and use it, along with first system data, to calculate advantage cluster applicability. Apparatus may calculate compatibility datum as a function of first system target convergence and advantage cluster applicability.

### FIELD OF THE INVENTION

The present invention generally relates to the field of data structure generation. In particular, the present invention is directed to systems and methods of data structure generation.

### BACKGROUND

Current methods for data structure generation and client selection may be insufficient, for example, in that they may fail to systematically account for available data on system target convergence and fit.

### SUMMARY OF THE DISCLOSURE

In an aspect, an apparatus for data structure generation includes at least a processor; and a memory communicatively connected to the at least processor, the memory containing instructions configuring the at least processor to identify one or more target convergence attributes; identify a high target convergence attribute pattern; obtain first system data; determine first system target convergence as a function of the high target convergence attribute pattern and the first system data; identify a plurality of second system attribute clusters; locate in the plurality of second system attribute clusters an advantage cluster; determine advantage cluster applicability as a function of the advantage cluster and the first system data; and determine a compatibility datum as a function of the first system target convergence and the advantage cluster applicability.

In another aspect, a method of data structure generation includes using at least a processor, identifying one or more target convergence attributes; using at least a processor, identifying a high target convergence attribute pattern; using at least a processor, obtaining first system data; using at least a processor, determining first system target convergence as a function of the high target convergence attribute pattern and the first system data; using at least a processor, identifying a plurality of second system attribute clusters; using at least a processor, locating in the plurality of second system attribute clusters an advantage cluster; using at least a processor, determining advantage cluster applicability as a function of the advantage cluster and the first system data; and using at least a processor, determining a compatibility datum as a function of the first system target convergence and the advantage cluster applicability.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a diagram depicting an exemplary apparatus for data structure generation;

FIG. 2 is a diagram depicting an exemplary machine learning model;

FIG. 3 is a diagram depicting an exemplary neural network;

FIG. 4 is a diagram depicting an exemplary neural network node;

FIG. 5 is a diagram depicting an exemplary method of data structure generation;

FIG. 6 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for data structure generation. In some embodiments, processor may determine a measure of the desirability of first system, and a measure of the degree to which the talents of second system meet the needs of first system. Processor may then use these data points to determine whether second system should select first system as a client. Processor may display this recommendation to a user.

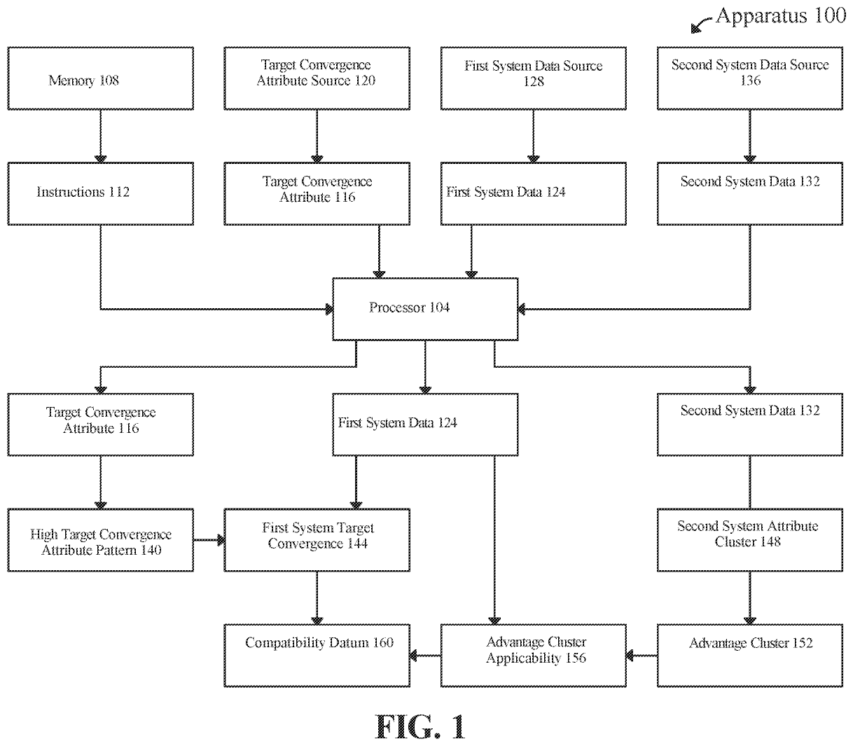

Referring now to FIG. 1, an exemplary embodiment of an apparatus 100 for data structure generation is illustrated. Apparatus 100 may include a computing device. Apparatus 100 may include a processor. Processor may include, without limitation, any processor described in this disclosure. Processor may be included in a computing device. Computing device may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Computing device may include a single computing device operating independently, or may include two or more computing device operating in concert, in parallel, sequentially or the like; two or more computing devices may be included together in a single computing device or in two or more computing devices. Computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device may include but is not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented, as a non-limiting example, using a “shared nothing” architecture.

With continued reference to FIG. 1, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, in some embodiments, apparatus 100 may include at least a processor 104 and a memory 108 communicatively connected to the at least a processor 104, the memory 108 containing instructions 112 configuring the at least a processor 104 to perform one or more processes described herein. Computing devices including memory 108 and at least a processor 104 are described in further detail herein.

Still referring to FIG. 1, as used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Still referring to FIG. 1, in some embodiments, apparatus 100 may identify one or more target convergence attributes 116. In some embodiments, apparatus 100 may include at least a processor 104 and memory 108 communicatively connected to the at least processor 104, the memory 108 containing instructions 112 configuring the at least processor 104 to identify one or more target convergence attributes 116.

Still referring to FIG. 1, as used herein, a “target convergence attribute” is an attribute that has a high correlation with a distance metric. An attribute may include any or all of a feature, section, knowledge, asset, or skill of a system. In some embodiments, a system may include an entity. In non-limiting examples, an entity may include an individual or corporate entity. In non-limiting examples, if an entity is a company, an attribute may include a branch of the company or a particular area of expertise of employees of the company.

Still referring to FIG. 1, as used herein, a “distance metric” is a distance to a target value. In non-limiting examples, target value may include a rating of the quality, desirability, or fit of a system. In some embodiments, a target convergence attribute may have a high correlation with a single distance metric. In a non-limiting example, second system may keep records of many current and/or former clients, including ratings as to how desirable of a client each is, and records of several other parameters, such as how quickly each client responds to messages, how quickly each client pays its bills, the amount of work generated by each client, the nature of the work generated by each client, the revenue generated based on the work associated with each client, and the like. In this example, the ratings of how desirable each client is may be used as a target value, and the records of the several other parameters may describe attributes. In this example, if quick responses to messages is highly correlated with the distance metric, then message response time may be determined to be a target convergence attribute.

Still referring to FIG. 1, in some embodiments, a target convergence attribute may have a high correlation with one or more distance metrics. In some embodiments, one distance metric, one distance metric of a plurality of distance metrics, and/or a plurality of distance metrics may factor into a determination as to whether an attribute is a target convergence attribute. In a non-limiting example, a plurality of distance metrics across different dimensions may be assigned weights and their weighted sum may be used to determine whether an attribute is a target convergence attribute. In a non-limiting example, second system may keep records of many current and/or former clients, including the amount of work generated by each client, the revenue per hour of work generated by each client, and records of several other parameters, such as how quickly each client responds to messages, how quickly each client pays its bills, the nature of the work generated by each client, and the like. In this example, a first distance metric may describe the degree of correlation between the amount of work generated by a client and the records of the other parameters. In this example, a second distance metric may describe the degree of correlation between the revenue per hour of work generated by each client and the records of the other parameters. In this example, whether an attribute is a target convergence attribute may be determined based on the first and second distance metrics. In this example, whether an attribute is a target convergence attribute may be determined based on a weighted sum of the first and second distance metrics.

Still referring to FIG. 1, in some embodiments, identifying one or more target convergence attributes may include generating a target convergence attribute data set. Generating a target convergence attribute data set may include collecting data on systems that second system has previously worked with. In some embodiments, such data may be obtained from records already kept by second system. In some embodiments, additional data may be collected. Data collection methods are described below with reference to first system data. Generating a target convergence attribute data set may include collecting target values. In a non-limiting example, target values may be collected by manually rating systems that second system currently works with or has previously worked with. In another non-limiting example, a metric such as the revenue generated by the work associated with each client may be used as a target value. In some embodiments, an attribute classifier may be used to determine attributes, as described below with reference to a second system attribute classifier. In some embodiments, such a classifier (or a target convergence attribute machine learning model described below) may select from attributes from a predetermined attribute list as described in that section.

Still referring to FIG. 1, in some embodiments, a target convergence attribute machine learning model may be used to determine target convergence attribute 116. Target convergence attribute machine learning model may be trained using a supervised learning machine learning algorithm. Target convergence attribute machine learning model may be trained using a data set including system data, associated with target values. In some embodiments, target convergence attribute machine learning model may include a regression algorithm. In some embodiments, a trained regression model from target convergence attribute machine learning model may be used to determine target convergence attributes. In a non-limiting example, if linear regression is used, then the slope of the trained model with respect to a single variable associated with an attribute and how well the resulting line fits the data may indicate the degree to which that attribute is correlated with target values. In some embodiments, a processor may select target convergence attributes based on the correlation and fit of the trained model with respect to an attribute. For example, a processor may determine high correlation and low variance attributes to be target convergence attributes. For example, if market cap has a high correlation and low variance with respect to distance metrics, then market cap may be included in the set of target convergence attributes. But if distance to a system's office has low correlation with respect to target values, then it may not be included. In some embodiments, degree of correlation and/or degree of fit may be compared to a threshold in order to determine whether an attribute is a target convergence attribute.

Additionally, or alternatively, target convergence attributes may be received from a target convergence attribute source 120. Target convergence attribute source 120 may include, in a non-limiting example, a user device. Users may input desired attributes into user device, and those may be used as target convergence attributes. User input methods are described below with reference to first system data.

Still referring to FIG. 1, in some embodiments, apparatus 100 may identify high target convergence attribute pattern 140. In some embodiments, apparatus 100 may include at least a processor 104 and memory 108 communicatively connected to the at least processor 104, the memory 108 containing instructions 112 configuring the at least processor 104 to identify high target convergence attribute pattern 140.

Still referring to FIG. 1, as used herein, a “high target convergence attribute pattern” is a data structure that describes at least a distance metric across an n-dimensional space, where the dimensions of the n-dimensional space are target convergence attributes and n is the number of target convergence attributes. In some embodiments, a high target convergence attribute pattern may distinguish between regions of high and low distance metric values. For example, a high target convergence attribute pattern may include a decision boundary, such as a decision boundary generated by a classification algorithm, where points on one side of the decision boundary may be predicted to have lower distance metric values than points on the other side of the decision boundary. In another example, a high target convergence attribute pattern may include a formula for predicting values of system target convergence given system attributes; such a formula may be generated using a regression machine learning algorithm. In some embodiments, at least a distance metric may include a single distance metric. In some embodiments, at least a distance metric may include a function including a plurality of distance metrics. As non-limiting examples, at least a distance metric may include a weighted sum of multiple distance metrics.

Still referring to FIG. 1, in some embodiments, an attribute pattern machine learning model may be used to identify high target convergence attribute pattern 140. In some embodiments, attribute pattern machine learning model may use a supervised learning algorithm. In some embodiments, attribute pattern machine learning model may include a classifier. In some embodiments, attribute pattern machine learning model may include a regression algorithm. For example, attribute pattern machine learning model may be trained using a data set including system data associated with distance metrics, where only system data corresponding to a target convergence attribute is considered rather than a broader set of system data. In some embodiments, training attribute pattern machine learning model may result in a mathematical model associating system data with target convergence attributes. As an example, if a classification algorithm is used, then a mathematical model may include a decision boundary separating points associated with higher target values from points associated with lower target values. As another example, if a regression algorithm is used, then a mathematical model may include a formula for predicting target values given system data.

Still referring to FIG. 1, a variety of mathematical models may be used to determine a high target convergence attribute pattern. For instance, a regression model may be trained on past or current first system data in order to determine a mathematical formula that fits the data and predicts where additional first systems will fall based on data specific to those first systems.

Still referring to FIG. 1, in another example, a classifier may be used to categorize past or current first system data, and a clustering algorithm may be used to determine groups of first systems. In this example, a first system attribute pattern may depend on whether a prospective first system falls within such a group. For example, if a prospective first system is determined to fall within a prospective cluster that is associated with high target convergence first systems, then such a first system may be selected as described below.

Still referring to FIG. 1, in some embodiments, apparatus 100 may obtain first system data 124. In some embodiments, apparatus 100 may include at least a processor 104 and memory 108 communicatively connected to the at least processor 104, the memory 108 containing instructions 112 configuring the at least processor 104 to obtain first system data 124.

Still referring to FIG. 1, as used herein, “first system data” is data associated with a first system. In some embodiments, first system data 124 may include data describing the industry in which first system operates, the business practices of first system, the business relationship between first system and second system, the business relationship between first system and another system in the same industry as second system, financial information associated with first system, identifying information on management of first system, and the like. As non-limiting examples, first system data 124 may include information relating to past projects completed for first system by other systems in the same industry as second system, the revenue of first system, and descriptions of interactions with first system management.

Still referring to FIG. 1, first system data 124 may be received from a first system data source 128. As used herein, a “first system data source” is a user, memory, or data structure containing first system data. In some embodiments, first system data source 128 may include one or more user devices, databases, computing devices, and/or users. In non-limiting examples, user devices may include smartphones, smartwatches, tablets, and computers. In some embodiments, a first system data source 128 may include a physical or digital form such as a form on a website or in an application. Exemplary forms include forms collecting first system data such as the reviews of interactions with first system employees. As another non-limiting example, a first system data source 128 may include a computing device configured to receive first system data 124 using digital tracking, such as gathering information using a device fingerprint that allows a user device to be tracked across the internet. As a non-limiting example, a device fingerprint may allow a user device to be tracked to social media websites. In some embodiments, first system data 124 may be received from a third party. In a non-limiting example, a third party may operate a database including first system data 124, processor 104 may request first system data 124 from the database using an application programming interface (API), and processor 104 may receive from the database, or a computing device associated with the database, first system data 124.

Still referring to FIG. 1, first system data 124 may be input through an interface. An interface may include a graphical user interface (GUI). An interface may include a touch-screen GUI interface. An interface may include a computing device configured to receive an input from a user. In some embodiments. an interface may be configured to prompt a user for an input. In a non-limiting example, an interface may request that a user input the date at which they had an interaction with an employee of first system and a description of the interaction.

Still referring to FIG. 1, in some embodiments, a first system data source 128 may include a web crawler or may store first system data 124 obtained using a web crawler. A web crawler may be configured to automatically search and collect information related to first system. As used herein, a “web crawler” is a program that systematically browses the internet for the purpose of web indexing. The web crawler may be seeded with platform URLs, wherein the crawler may then visit the next related URL, retrieve the content, index the content, and/or measures the relevance of the content to the topic of interest. In one embodiment, the web crawler may be configured to scrape first system data 124 from user related social media and networking platforms. The web crawler may be trained with information received from a user through a user interface. As a non-limiting example, a user may input into a user interface, social media platforms they have accounts on and would like to retrieve user data from. A user interface may include a graphical user interface (GUI), command line interface (CLI), menu-driven user interface, touch user interface, voice user interface (VUI), form-based user interface, and the like. Processor may receive first system data 124 including information such as a user's name, user's profile, platform handles, platforms associated with the user, industry, descriptions of interactions associated with first system, descriptions of current and upcoming projects first system is working on, data which may be used to verify data input by a user and the like. In some embodiments, a web crawler may be configured to generate a web query. A web query may include search criteria. Search criteria may include photos, videos, audio, user account handles, web page addresses and the like received from the user. A web crawler function may be configured to search for and/or detect one or more data patterns. A “data pattern” as used in this disclosure is any repeating forms of information. A data pattern may include, but is not limited to, features, phrases, and the like as described further below in this disclosure.

Still referring to FIG. 1, in some embodiments, a web crawler may work in tandem with a program designed to interpret information retrieved using a web crawler. As a non-limiting example, a machine learning model may be used to generate a new query as a function of prior search results. As another non-limiting example, data may be processed into another form, such as by using optical character recognition to interpret images of text. In some embodiments, a web crawler may be configured to determine the relevancy of a data pattern. Relevancy may be determined by a relevancy score. A relevancy score may be automatically generated by processor 104, received from a machine learning model, and/or received from a user. In some embodiments, a relevancy score may include a range of numerical values that may correspond to a relevancy strength of data received from a web crawler function. As a non-limiting example, a web crawler function may search the Internet for data related to an interaction associated with a user. In some embodiments, computing device may determine a relevancy score of first system data 124 retrieved by a web crawler.

Still referring to FIG. 1, in some embodiments, first system data may be converted into a different form. Data formats may be converted in a variety of ways, such as without limitation, using a speech to text function or using optical character recognition. In some embodiments, first system data may be converted into a different form such that it is in a form appropriate for input into a function. As a non-limiting example, a language model may only accept inputs in a particular format, and first system data may be converted into that format such that it may be effectively input into the language model.

Still referring to FIG. 1, data may also be altered such that it retains the same format but is more likely to produce successful or relevant results. As a non-limiting example, a machine learning model may be used to replace obscure words in a text file with more common words that have similar or identical meanings. In this example, this may be done by training a machine learning model on samples of text using unsupervised learning such that the machine learning model learns associations between words (such as based on how frequently they are used together). In this example, words may be represented as vectors with dimensions indicating their relationship to other words, and whether words are synonyms may be determined based on how similar their vectors are (as in, if vectors representing 2 words point in the same direction, those words may be synonyms). In this example, a first word determined to be similar to or a synonym of a second word, may be replaced by the second word.

Still referring to FIG. 1, an exemplary sequence of data modification is as follows: (1) system data may be gathered in an image format, (2) OCR may be applied to this data to create a text file interpreting text depicted in the image, (3) a language model may be used to extract data from the text file (for example, if the text file discloses the revenue of a system, then that figure may be identified), and (4) that data may be used as part of a data set for identifying target convergence attributes. Similar sequences of data modification may be done using, for example, automatic speech recognition to generate a text file from an audio file before continuing with a similar process as immediately above.

Still referring to FIG. 1, first system data may include image data. In some embodiments, image data may be processed using optical character recognition. In some embodiments, optical character recognition or optical character reader (OCR) includes automatic conversion of images of written (e.g., typed, handwritten or printed text) into machine-encoded text. In some cases, recognition of at least a keyword from image data may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine-learning processes. In some cases, intelligent word recognition (IWR) may recognize written text, one word at a time, for instance by employing machine-learning processes.

Still referring to FIG. 1, in some cases OCR may be an “offline” process, which analyses a static document or image frame. In some cases, handwriting movement analysis can be used as input to handwriting recognition. For example, instead of merely using shapes of glyphs and words, this technique may capture motions, such as the order in which segments are drawn, the direction, and the pattern of putting the pen down and lifting it. This additional information may make handwriting recognition more accurate. In some cases, this technology may be referred to as “online” character recognition, dynamic character recognition, real-time character recognition, and intelligent character recognition.

Still referring to FIG. 1, in some cases, OCR processes may employ pre-processing of image data. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to image data to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from a background of image data. In some cases, binarization may be required for example if an employed OCR algorithm only works on binary images. In some cases, a line removal process may include removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify script allowing an appropriate OCR algorithm to be selected. In some cases, a character isolation or “segmentation” process may separate signal characters, for example character-based OCR algorithms. In some cases, a normalization process may normalize aspect ratio and/or scale of image data.

Still referring to FIG. 1, in some embodiments an OCR process may include an OCR algorithm. Exemplary OCR algorithms include matrix matching process and/or feature extraction processes. Matrix matching may involve comparing an image to a stored glyph on a pixel-by-pixel basis. In some case, matrix matching may also be known as “pattern matching,” “pattern recognition,” and/or “image correlation.” Matrix matching may rely on an input glyph being correctly isolated from the rest of image data. Matrix matching may also rely on a stored glyph being in a similar font and at a same scale as input glyph. Matrix matching may work best with typewritten text.

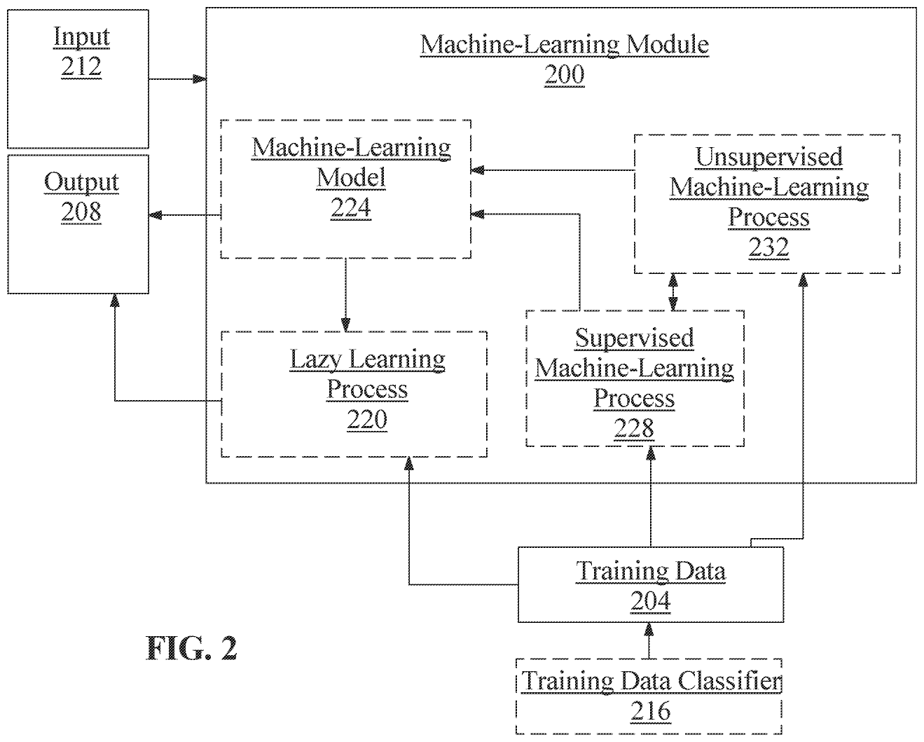

Still referring to FIG. 1, in some embodiments, an OCR process may include a feature extraction process. In some cases, feature extraction may decompose a glyph into at least a feature. Exemplary non-limiting features may include corners, edges, lines, closed loops, line direction, line intersections, and the like. In some cases, feature extraction may reduce dimensionality of representation and may make the recognition process computationally more efficient. In some cases, extracted feature may be compared with an abstract vector-like representation of a character, which might reduce to one or more glyph prototypes. General techniques of feature detection in computer vision are applicable to this type of OCR. In some embodiments, machine-learning processes like nearest neighbor classifiers (e.g., k-nearest neighbors algorithm) may be used to compare image features with stored glyph features and choose a nearest match. OCR may employ any machine-learning process described in this disclosure, for example machine-learning processes described with reference to FIGS. 2-4. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

Still referring to FIG. 1, in some cases, OCR may employ a two-pass approach to character recognition. A first pass may try to recognize a character. Each character that is satisfactory is passed to an adaptive classifier as training data. The adaptive classifier then gets a chance to recognize characters more accurately as it further analyzes image data. Since the adaptive classifier may have learned something useful a little too late to recognize characters on the first pass, a second pass is run over the image data. Second pass may include adaptive recognition and use characters recognized with high confidence on the first pass to recognize better remaining characters on the second pass. In some cases, two-pass approach may be advantageous for unusual fonts or low-quality image data. Another exemplary OCR software tool include OCRopus. OCRopus development is led by German Research Centre for Artificial Intelligence in Kaiserslautern, Germany. In some cases, OCR software may employ neural networks.

Still referring to FIG. 1, in some cases, OCR may include post-processing. For example, OCR accuracy may be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of image data. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make us of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

Still referring to FIG. 1, first system data may include speech data. In some embodiments, speech data may be processed using automatic speech recognition. In some embodiments, automatic speech recognition may require training (i.e., enrollment). In some cases, training an automatic speech recognition model may require an individual speaker to read text or isolated vocabulary. In some cases, speech training data may include an audio component having an audible verbal content, the contents of which are known a priori by a computing device. Computing device may then train an automatic speech recognition model according to training data which includes audible verbal content correlated to known content. In this way, computing device may analyze a person's specific voice and train an automatic speech recognition model to the person's speech, resulting in increased accuracy. Alternatively, or additionally, in some cases, computing device may include an automatic speech recognition model that is speaker independent. As used in this disclosure, a “speaker independent” automatic speech recognition process does not require training for each individual speaker. Conversely, as used in this disclosure, automatic speech recognition processes that employ individual speaker specific training are “speaker dependent.”

Still referring to FIG. 1, in some embodiments, an automatic speech recognition process may perform voice recognition or speaker identification. As used in this disclosure, “voice recognition” refers to identifying a speaker, from audio content, rather than what the speaker is saying. In some cases, computing device may first recognize a speaker of verbal audio content and then automatically recognize speech of the speaker, for example by way of a speaker dependent automatic speech recognition model or process. In some embodiments, an automatic speech recognition process can be used to authenticate or verify an identity of a speaker. In some cases, a speaker may or may not include subject. For example, subject may speak within speech data, but others may speak as well.

Still referring to FIG. 1, in some embodiments, an automatic speech recognition process may include one or all of acoustic modeling, language modeling, and statistically based speech recognition algorithms. In some cases, an automatic speech recognition process may employ hidden Markov models (HMMs). As discussed in greater detail below, language modeling such as that employed in natural language processing applications like document classification or statistical machine translation, may also be employed by an automatic speech recognition process.

Still referring to FIG. 1, an exemplary algorithm employed in automatic speech recognition may include or even be based upon hidden Markov models. Hidden Markov models (HMMs) may include statistical models that output a sequence of symbols or quantities. HMMs can be used in speech recognition because a speech signal can be viewed as a piecewise stationary signal or a short-time stationary signal. For example, over a short time scale (e.g., 10 milliseconds), speech can be approximated as a stationary process. Speech (i.e., audible verbal content) can be understood as a Markov model for many stochastic purposes.

Still referring to FIG. 1, in some embodiments HMMs can be trained automatically and may be relatively simple and computationally feasible to use. In an exemplary automatic speech recognition process, a hidden Markov model may output a sequence of n-dimensional real-valued vectors (with n being a small integer, such as 10), at a rate of about one vector every 10 milliseconds. Vectors may consist of cepstral coefficients. A cepstral coefficient requires using a spectral domain. Cepstral coefficients may be obtained by taking a Fourier transform of a short time window of speech yielding a spectrum, decorrelating the spectrum using a cosine transform, and taking first (i.e., most significant) coefficients. In some cases, an HMM may have in each state a statistical distribution that is a mixture of diagonal covariance Gaussians, yielding a likelihood for each observed vector. In some cases, each word, or phoneme, may have a different output distribution; an HMM for a sequence of words or phonemes may be made by concatenating an HMMs for separate words and phonemes.

Still referring to FIG. 1, in some embodiments, an automatic speech recognition process may use various combinations of a number of techniques in order to improve results. In some cases, a large-vocabulary automatic speech recognition process may include context dependency for phonemes. For example, in some cases, phonemes with different left and right context may have different realizations as HMM states. In some cases, an automatic speech recognition process may use cepstral normalization to normalize for different speakers and recording conditions. In some cases, an automatic speech recognition process may use vocal tract length normalization (VTLN) for male-female normalization and maximum likelihood linear regression (MLLR) for more general speaker adaptation. In some cases, an automatic speech recognition process may determine so-called delta and delta-delta coefficients to capture speech dynamics and might use heteroscedastic linear discriminant analysis (HLDA). In some cases, an automatic speech recognition process may use splicing and a linear discriminate analysis (LDA)-based projection, which may include heteroscedastic linear discriminant analysis or a global semi-tied covariance transform (also known as maximum likelihood linear transform [MLLT]). In some cases, an automatic speech recognition process may use discriminative training techniques, which may dispense with a purely statistical approach to HMM parameter estimation and instead optimize some classification-related measure of training data; examples may include maximum mutual information (MMI), minimum classification error (MCE), and minimum phone error (MPE).

Still referring to FIG. 1, in some embodiments, an automatic speech recognition process may be said to decode speech (i.e., audible verbal content). Decoding of speech may occur when an automatic speech recognition system is presented with a new utterance and must compute a most likely sentence. In some cases, speech decoding may include a Viterbi algorithm. A Viterbi algorithm may include a dynamic programming algorithm for obtaining a maximum a posteriori probability estimate of a most likely sequence of hidden states (i.e., Viterbi path) that results in a sequence of observed events. Viterbi algorithms may be employed in context of Markov information sources and hidden Markov models. A Viterbi algorithm may be used to find a best path, for example using a dynamically created combination hidden Markov model, having both acoustic and language model information, using a statically created combination hidden Markov model (e.g., finite state transducer [FST] approach).

Still referring to FIG. 1, in some embodiments, speech (i.e., audible verbal content) decoding may include considering a set of good candidates and not only a best candidate, when presented with a new utterance. In some cases, a better scoring function (i.e., re-scoring) may be used to rate each of a set of good candidates, allowing selection of a best candidate according to this refined score. In some cases, a set of candidates can be kept either as a list (i.e., N-best list approach) or as a subset of models (i.e., a lattice). In some cases, re-scoring may be performed by optimizing Bayes risk (or an approximation thereof). In some cases, re-scoring may include optimizing for sentence (including keywords) that minimizes an expectancy of a given loss function with regards to all possible transcriptions. For example, re-scoring may allow selection of a sentence that minimizes an average distance to other possible sentences weighted by their estimated probability. In some cases, an employed loss function may include Levenshtein distance, although different distance calculations may be performed, for instance for specific tasks. In some cases, a set of candidates may be pruned to maintain tractability.

Still referring to FIG. 1, in some embodiments, an automatic speech recognition process may employ dynamic time warping (DTW)-based approaches. Dynamic time warping may include algorithms for measuring similarity between two sequences, which may vary in time or speed. For instance, similarities in walking patterns would be detected, even if in one video the person was walking slowly and if in another he or she were walking more quickly, or even if there were accelerations and deceleration during the course of one observation. DTW has been applied to video, audio, and graphics-indeed, any data that can be turned into a linear representation can be analyzed with DTW. In some cases, DTW may be used by an automatic speech recognition process to cope with different speaking (i.e., audible verbal content) speeds. In some cases, DTW may allow computing device to find an optimal match between two given sequences (e.g., time series) with certain restrictions. That is, in some cases, sequences can be “warped” non-linearly to match each other. In some cases, a DTW-based sequence alignment method may be used in context of hidden Markov models.

Still referring to FIG. 1, in some embodiments, an automatic speech recognition process may include a neural network. Neural network may include any neural network, for example those disclosed with reference to FIGS. 2-4. In some cases, neural networks may be used for automatic speech recognition, including phoneme classification, phoneme classification through multi-objective evolutionary algorithms, isolated word recognition, audiovisual speech recognition, audiovisual speaker recognition and speaker adaptation. In some cases, neural networks employed in automatic speech recognition may make fewer explicit assumptions about feature statistical properties than HMMs and therefore may have several qualities making them attractive recognition models for speech recognition. When used to estimate the probabilities of a speech feature segment, neural networks may allow discriminative training in a natural and efficient manner. In some cases, neural networks may be used to effectively classify audible verbal content over short-time intervals, for instance such as individual phonemes and isolated words. In some embodiments, a neural network may be employed by automatic speech recognition processes for pre-processing, feature transformation and/or dimensionality reduction, for example prior to HMM-based recognition. In some embodiments, long short-term memory (LSTM) and related recurrent neural networks (RNNs) and Time Delay Neural Networks (TDNN's) may be used for automatic speech recognition, for example over longer time intervals for continuous speech recognition.

Still referring to FIG. 1, in some embodiments, apparatus 100 may include at least a camera. As used in this disclosure, a “camera” is a device that is configured to sense electromagnetic radiation, such as without limitation visible light, and generate an image representing the electromagnetic radiation. In some cases, a camera may include one or more optics. Exemplary non-limiting optics include spherical lenses, aspherical lenses, reflectors, polarizers, filters, windows, aperture stops, and the like. In some cases, at least a camera may include an image sensor. Exemplary non-limiting image sensors include digital image sensors, such as without limitation charge-coupled device (CCD) sensors and complimentary metal-oxide-semiconductor (CMOS) sensors, chemical image sensors, and analog image sensors, such as without limitation film. In some cases, a camera may be sensitive within a non-visible range of electromagnetic radiation, such as without limitation infrared. As used in this disclosure, “image data” is information representing at least a physical scene, space, and/or object. In some cases, image data may be generated by a camera. “Image data” may be used interchangeably through this disclosure with “image,” where image is used as a noun. An image may be optical, such as without limitation where at least an optic is used to generate an image of an object. An image may be material, such as without limitation when film is used to capture an image. An image may be digital, such as without limitation when represented as a bitmap. Alternatively, an image may be comprised of any media capable of representing a physical scene, space, and/or object. Alternatively, where “image” is used as a verb, in this disclosure, it refers to generation and/or formation of an image.

Still referring to FIG. 1, in some embodiments, apparatus 100 may include a machine vision system. In some embodiments, a machine vision system may include at least a camera. A machine vision system may use images, such as images from at least a camera, to make a determination about a scene, space, and/or object. For example, in some cases a machine vision system may be used for world modeling or registration of objects within a space. In some cases, registration may include image processing, such as without limitation object recognition, feature detection, edge/corner detection, and the like. Non-limiting examples of feature detection may include scale invariant feature transform (SIFT), Canny edge detection, Shi Tomasi corner detection, and the like. In some cases, registration may include one or more transformations to orient a camera frame (or an image or video stream) relative a three-dimensional coordinate system; exemplary transformations include without limitation homography transforms and affine transforms. In an embodiment, registration of first frame to a coordinate system may be verified and/or corrected using object identification and/or computer vision, as described above. For instance, and without limitation, an initial registration to two dimensions, represented for instance as registration to the x and y coordinates, may be performed using a two-dimensional projection of points in three dimensions onto a first frame, however. A third dimension of registration, representing depth and/or a z axis, may be detected by comparison of two frames; for instance, where first frame includes a pair of frames captured using a pair of cameras (e.g., stereoscopic camera also referred to in this disclosure as stereo-camera), image recognition and/or edge detection software may be used to detect a pair of stereoscopic views of images of an object; two stereoscopic views may be compared to derive z-axis values of points on object permitting, for instance, derivation of further z-axis points within and/or around the object using interpolation. This may be repeated with multiple objects in field of view, including without limitation environmental features of interest identified by object classifier and/or indicated by an operator. In an embodiment, x and y axes may be chosen to span a plane common to two cameras used for stereoscopic image capturing and/or an xy plane of a first frame; a result, x and y translational components and ø may be pre-populated in translational and rotational matrices, for affine transformation of coordinates of object, also as described above. Initial x and y coordinates and/or guesses at transformational matrices may alternatively or additionally be performed between first frame and second frame, as described above. For each point of a plurality of points on object and/or edge and/or edges of object as described above, x and y coordinates of a first stereoscopic frame may be populated, with an initial estimate of z coordinates based, for instance, on assumptions about object, such as an assumption that ground is substantially parallel to an xy plane as selected above. Z coordinates, and/or x, y, and z coordinates, registered using image capturing and/or object identification processes as described above may then be compared to coordinates predicted using initial guess at transformation matrices; an error function may be computed using by comparing the two sets of points, and new x, y, and/or z coordinates, may be iteratively estimated and compared until the error function drops below a threshold level. In some cases, a machine vision system may use a classifier, such as any classifier described throughout this disclosure.

Still referring to FIG. 1, an exemplary machine vision camera is an OpenMV Cam H7 from OpenMV, LLC of Atlanta, Georgia, U.S.A. OpenMV Cam comprises a small, low power, microcontroller which allows execution of machine vision applications. OpenMV Cam comprises an ARM Cortex M7 processor and a 640×480 image sensor operating at a frame rate up to 150 fps. OpenMV Cam may be programmed with Python using a Remote Python/Procedure Call (RPC) library. OpenMV CAM may be used to operate image classification and segmentation models, such as without limitation by way of TensorFlow Lite; detection motion, for example by way of frame differencing algorithms; marker detection, for example blob detection; object detection, for example face detection; eye tracking; person detection, for example by way of a trained machine learning model; camera motion detection, for example by way of optical flow detection; code (barcode) detection and decoding; image capture; and video recording.

Still referring to FIG. 1, in some embodiments, a language model may be used to process first system data. As used herein, a “language model” is a program capable of interpreting natural language, generating natural language, or both. In some embodiments, a language model may be configured to interpret the output of an automatic speech recognition function and/or an OCR function. A language model may include a neural network. A language model may be trained using a dataset that includes natural language.

Still referring to FIG. 1, generating language model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

Still referring to FIG. 1, processor 104 may determine one or more language elements in first system data by identifying and/or detecting associations between one or more language elements (including phonemes or phonological elements, morphemes or morphological elements, syntax or syntactic elements, semantics or semantic elements, and pragmatic elements) extracted from at least user data and/or response, including without limitation mathematical associations, between such words. Associations between language elements and relationships of such categories to other such term may include, without limitation, mathematical associations, including without limitation statistical correlations between any language element and any other language element and/or Language elements. Processor 104 may compare an input such as a sentence from first system data with a list of keywords or a dictionary to identify language elements. For example, processor 104 may identify whitespace and punctuation in a sentence and extract elements comprising a string of letters, numbers or characters occurring adjacent to the whitespace and punctuation. Processor 104 may then compare each of these with a list of keywords or a dictionary. Based on the determined keywords or meanings associated with each of the strings, processor 104 may determine an association between one or more of the extracted strings and a feature of an organization operating apparatus 100, such as an association between a string containing the words “oncology” and “therapies” and a system developing an anti-cancer drug. Associations may take the form of statistical correlations and/or mathematical associations, which may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory.

Still referring to FIG. 1, processor 104 may be configured to determine one or more language elements in first system data using machine learning. For example, processor 104 may generate the language processing model by any suitable method, including without limitation a natural language processing classification algorithm; language processing model may include a natural language process classification model that enumerates and/or derives statistical relationships between input terms and output terms. An algorithm to generate language processing model may include a stochastic gradient descent algorithm, which may include a method that iteratively optimizes an objective function, such as an objective function representing a statistical estimation of relationships between terms, including relationships between input language elements and output patterns or conversational styles in the form of a sum of relationships to be estimated. In an alternative or additional approach, sequential tokens may be modeled as chains, serving as the observations in a Hidden Markov Model (HMM). HMMs as used herein are statistical models with inference algorithms that that may be applied to the models. In such models, a hidden state to be estimated may include an association between an extracted word, phrase, and/or other semantic unit. There may be a finite number of categories to which an extracted word may pertain; an HMM inference algorithm, such as the forward-backward algorithm or the Viterbi algorithm, may be used to estimate the most likely discrete state given a word or sequence of words. Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

Still referring to FIG. 1, processor 104 may be configured to determine one or more language elements in first system data using machine learning by first creating or receiving language classification training data. Training data may include data containing correlations that a machine-learning process may use to model relationships between two or more categories of data elements. For instance, and without limitation, training data may include a plurality of data entries, each entry representing a set of data elements that were recorded, received, and/or generated together; data elements may be correlated by shared existence in a given data entry, by proximity in a given data entry, or the like. Multiple data entries in training data may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data according to various correlations; correlations may indicate causative and/or predictive links between categories of data elements, which may be modeled as relationships such as mathematical relationships by machine-learning processes as described in further detail below. Training data may be formatted and/or organized by categories of data elements, for instance by associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements; for instance, and without limitation, training data may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Still referring to FIG. 1, training data may include one or more elements that are not categorized; that is, training data may not be formatted or contain descriptors for some elements of data. Machine-learning algorithms and/or other processes may sort training data according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data to be made applicable for two or more distinct machine-learning algorithms as described in further detail below.

Still referring to FIG. 1, language classification training data may be a training data set containing associations between language element inputs and associated language element outputs. Language element inputs and outputs may be categorized by communication form such as written language elements, spoken language elements, typed language elements, or language elements communicated in any suitable manner. Language elements may be categorized by component type, such as phonemes or phonological elements, morphemes or morphological elements, syntax or syntactic elements, semantics or semantic elements, and pragmatic elements. Associations may be made between similar communication types of language elements (e.g. associating one written language element with another written language element) or different language elements (e.g. associating a spoken language element with a written representation of the same language element). Associations may be identified between similar communication types of two different language elements, for example written input consisting of the syntactic element “that” may be associated with written phonemes /th/, /ă/, and /t/. Associations may be identified between different communication forms of different language elements. For example, the spoken form of the syntactic element “that” and the associated written phonemes above. Language classification training data may be created using a classifier such as a language classifier. An exemplary classifier may be created, instantiated, and/or run using processor 104, or another computing device. Language classification training data may create associations between any type of language element in any format and other type of language element in any format. Additionally, or alternatively, language classification training data may associate language element input data to a feature related to a system. For example, language classification training data may associate occurrences of the syntactic elements “100k,” and “revenue” in a single sentence with the feature of having an annual revenue of $100,000.

Still referring to FIG. 1, processor 104 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P (A/B)=P (B/A) P (A)=P (B), where P (A/B) is the probability of hypothesis A given data B also known as posterior probability; P (B/A) is the probability of data B given that the hypothesis A was true; P (A) is the probability of hypothesis A being true regardless of data also known as prior probability of A; and P (B) is the probability of the data regardless of the hypothesis. A naïve Bayes algorithm may be generated by first transforming training data into a frequency table. Processor 104 may then calculate a likelihood table by calculating probabilities of different data entries and classification labels. Processor 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

Still referring to FIG. 1, processor 104 may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

Still referring to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

Still referring to FIG. 1, in some embodiments, apparatus 100 may determine a first system target convergence 144 as a function of high target convergence attribute pattern 140 and first system data 124. In some embodiments, apparatus 100 may include at least a processor 104 and memory 108 communicatively connected to the at least processor 104, the memory 108 containing instructions 112 configuring the at least processor 104 to determine first system target convergence 144 as a function of high target convergence attribute pattern 140 and first system data 124.

Still referring to FIG. 1, in some embodiments, determining first system target convergence 144 as a function of high target convergence attribute pattern 140 and first system data 124 may include analyzing the first system data and comparing the results with the high target convergence attribute pattern. Relevant aspects of first system data may be identified as described above (using, for example, a language model to automatically identify specific aspects of data from a larger set of documents). Specifically, first system data may be gathered and analyzed such that values are known for the target convergence attributes. As an example, if revenue, response time to messages, and whether or not a system is in the biotech industry are target convergence attributes, then first system data may be analyzed such that those data points are determined. These data points may be compared to the high target convergence attribute pattern in order to determine first system target convergence. In a non-limiting example, if high target convergence attribute pattern is determined using an attribute pattern machine learning model as described above, then determining first system target convergence may include inputting first system data into the attribute pattern machine learning model; and receiving first system target convergence from the attribute pattern machine learning model. If the results of a comparison between first system data and a high target convergence attribute pattern fit a pattern associated with high target convergence systems, then this may contribute to a decision to select the system as described below.

Still referring to FIG. 1, in some embodiments, apparatus 100 may identify a set of second system attribute clusters 148. In some embodiments, apparatus 100 may include at least a processor 104 and memory 108 communicatively connected to the at least processor 104, the memory 108 containing instructions 112 configuring the at least processor 104 to identify a set of second system attribute clusters 148.

Still referring to FIG. 1, identifying a set of second system attribute clusters 148 may include gathering second system data 132. Second system data may be gathered using methods of gathering data as described above with reference to first system data. Second system data may be received from a second system data source 136 such as a user device, server, database, and the like.

Still referring to FIG. 1, as used herein, an “attribute cluster” is a plurality of related attributes of a system. As described above, an attribute may include any or all of a feature, section, knowledge, asset, or skill of a system. In non-limiting examples, a second system attribute may include any or all of a feature, section, knowledge, asset, or skill of second system. In non-limiting examples, if second system is a company, second system attribute may include a branch of the company or a particular area of expertise of employees of the company. For example, a second system attribute may include expertise in a particular field. In another example, a second system attribute may include pre-made materials applicable to clients in a certain industry. In another example, a second system attribute may include certain business contacts of service provider management. In another example, a second system attribute may include partnerships between a second system and another system. Second system attribute cluster may include a single attribute of second system, or it may include more than one attribute. Second system attribute cluster may include multiple related second system attributes. In a non-limiting example, second system attribute cluster may include knowledge of how to paint and an inventory of paintbrushes. In another non-limiting example, second system attribute cluster may include knowledge of how to use several computer programs, each useful for an aspect of creating virtual artwork. In another non-limiting example, second system attribute cluster may include knowledge of how to use a single computer program.

Still referring to FIG. 1, in some embodiments, apparatus 100 may identify a plurality of second system attributes by using second system attribute classifier. Second system attribute classifier may receive as inputs second system data and predetermined attribute list and may output second system attribute. Second system attribute classifier may be trained on a dataset including historical system data associated with historical attributes. As a non-limiting example, second system attribute classifier may be trained on a dataset including, for each historical system in the dataset, historical system data associated with which computer programs employees of that system had expertise in; second system attribute classifier trained on such data may be capable of associating second system data with second system attributes, where the second system attributes include which computer programs employees of the system have expertise in. As another non-limiting example, second system attribute classifier may be trained on a dataset including, for each historical system in the dataset, historical system data associated with which physical assets such as machines and land that system possessed; second system attribute classifier trained on such data may be capable of associating second system data with second system attributes, where the second system attributes include which physical assets a system possesses. As another non-limiting example, second system attribute classifier may be trained on a dataset including, for each historical system in the dataset, historical system data associated with which languages employees of that system spoke; second system attribute classifier trained on such data may be capable of associating second system data with second system attributes, where the second system attributes include which languages employees of a system speak. System data may be processed before it is input into second system attribute classifier, such as using optical character recognition, a language model, and/or data type conversions as described above. Second system attribute classifier may also accept as an input predetermined attribute list and may associate second system data with attributes on the predetermined attribute list.

Still referring to FIG. 1, in some embodiments, second system attributes may additionally or alternatively be determined by manual input, determinations based on second system documents (which may be analyzed using a character recognition algorithm and a machine learning model) and determinations based on internet data on the second system, such as discussions of the second system online.

Still referring to FIG. 1, in some embodiments, apparatus 100 may identify a plurality of second system attribute clusters 148 by using a clustering algorithm. Clustering algorithm may be implemented, as a non-limiting example, using a k-means clustering algorithm. A “k-means clustering algorithm” as used in this disclosure, includes cluster analysis that partitions n attributes into k clusters in which each attribute belongs to the cluster with the nearest mean, using, for instance a training set described below. “Cluster analysis” as used in this disclosure, includes grouping a set of attributes in way that attributes in the same group or cluster are more similar to each other than to those in other groups or clusters. Cluster analysis may be performed by various cluster models that include connectivity models such as hierarchical clustering, centroid models such as k-means, distribution models such as multivariate normal distribution, density models such as density-based spatial clustering of applications with nose (DBSCAN) and ordering points to identify the clustering structure (OPTICS), subspace models such as biclustering, group models, graph-based models such as a clique, signed graph models, neural models, and the like. Cluster analysis may include hard clustering whereby each attribute belongs to a cluster or not. Cluster analysis may include soft clustering or fuzzy clustering whereby each attribute belongs to each cluster to a certain degree such as for example a likelihood of belonging to a cluster; for instance, and without limitation, a fuzzy clustering algorithm may be used to identify clustering of gene combinations with multiple disease states, and vice versa. Cluster analysis may include strict partitioning clustering whereby each attribute belongs to exactly one cluster. Cluster analysis may include strict partitioning clustering with outliers whereby attributes may belong to no cluster and may be considered outliers. Cluster analysis may include overlapping clustering whereby attributes may belong to more than one cluster. Cluster analysis may include hierarchical clustering whereby attributes that belong to a child cluster also belong to a parent cluster.

Still referring to FIG. 1, computing device may generate a k-means clustering algorithm receiving unclassified attributes and outputs a definite number of classified attribute clusters wherein the attribute clusters each contain one or more attributes. K-means algorithm may select a specific number of groups or clusters to output, identified by a variable “k.” Generating a k-means clustering algorithm includes assigning inputs containing unclassified data to a “k-group” or “k-cluster” based on feature similarity. Centroids of k-groups or k-clusters may be utilized to generate classified attribute cluster. K-means clustering algorithm may select and/or be provided “k” variable by calculating k-means clustering algorithm for a range of k values and comparing results. K-means clustering algorithm may compare results across different values of k as the mean distance between cluster attributes and cluster centroid. K-means clustering algorithm may calculate mean distance to a centroid as a function of k value, and the location of where the rate of decrease starts to sharply shift, this may be utilized to select a k value. Centroids of k-groups or k-cluster include a collection of feature values which are utilized to classify attribute clusters containing attributes.

Still referring to FIG. 1, generating a k-means clustering algorithm may include generating initial estimates for k centroids which may be randomly generated or randomly selected from unclassified data input. K centroids may be utilized to define one or more clusters. K-means clustering algorithm may assign unclassified data to one or more k-centroids based on the squared Euclidean distance by first performing a data assigned step of unclassified data. K-means clustering algorithm may assign unclassified data to its nearest centroid based on the collection of centroids ci of centroids in set C. Unclassified data may be assigned to a cluster based on [symbol] dist(ci, x)², where argmin includes argument of the minimum, ci includes a collection of centroids in a set C, and dist includes standard Euclidean distance. K-means clustering module may then recompute centroids by taking a mean of all cluster attributes assigned to a centroid's cluster. This may be calculated based on ci=1/|Si|Σxi [symbol] Si^{xi}. K-means clustering algorithm may continue to repeat these calculations until a stopping criterion has been satisfied such as when cluster attributes do not change clusters, the sum of the distances have been minimized, and/or some maximum number of iterations has been reached.

Still referring to FIG. 1, k-means clustering algorithm may be configured to calculate a degree of similarity index value. A “degree of similarity index value” as used in this disclosure, includes a distance measurement indicating a measurement between each attribute cluster generated by k-means clustering algorithm and a selected attribute. Degree of similarity index value may indicate how close a particular attribute is to being classified by k-means algorithm to a particular cluster. K-means clustering algorithm may evaluate the distances of the attribute to the k-number of clusters output by k-means clustering algorithm. Short distances between a set of attributes and a cluster may indicate a higher degree of similarity between the attribute and a particular cluster. Longer distances between attribute and a cluster may indicate a lower degree of similarity between attribute and a particular cluster.

Still referring to FIG. 1, k-means clustering algorithm selects a classified attribute as a function of the degree of similarity index value. In an embodiment, k-means clustering algorithm may select an attribute cluster with the smallest degree of similarity index value indicating a high degree of similarity between attribute and the attribute cluster. Alternatively, or additionally k-means clustering algorithm may select a plurality of clusters having low degree of similarity index values to attributes, indicative of greater degrees of similarity. Degree of similarity index values may be compared to a threshold number indicating a minimal degree of relatedness suitable for inclusion of attribute in a cluster, where degree of similarity indices a-n falling under the threshold number may be included as indicative of high degrees of relatedness. The above-described illustration of feature learning using k-means clustering is included for illustrative purposes only and should not be construed as limiting potential implementation of clustering algorithms; persons skilled in the art, upon reviewing the entirety of this disclosure, will be aware of various additional or alternative clustering approaches that may be used consistently with this disclosure.

Still referring to FIG. 1, in some embodiments, a k-means clustering algorithm may be trained on a dataset including a plurality of attributes that vary in one or more dimensions. In a non-limiting example, a set of attributes may include expertise in a variety of computer programs, and a variable may include the degree to which expertise in a computer program is correlated with the number of papers an individual with that expertise has written in a particular field; in this situation, a k-means clustering algorithm may be used to determine clusters among the training data, and attributes input into the algorithm may be assigned to these attribute clusters.

Still referring to FIG. 1, in some embodiments, particle swarm optimization is used to determine attribute clusters. In some embodiments, particle swarm optimization may involve a population of candidate solutions that are moved around in a search space as a function of the best-known position for that particle and the entire population's best-known position.

Still referring to FIG. 1, in some embodiments, apparatus 100 may locate in a set of second system attribute clusters 148 an advantage cluster 152. In some embodiments, apparatus 100 may include at least a processor 104 and memory 108 communicatively connected to the at least processor 104, the memory 108 containing instructions 112 configuring the at least processor 104 to locate in a set of second system attribute clusters 148 an advantage cluster 152.

Still referring to FIG. 1, in some embodiments, apparatus 100 may determine advantage cluster 152 as a function of impact metric. As used herein, an “advantage cluster” is an attribute cluster with an impact metric that differs substantially from a population average. In some embodiments, advantage cluster 152 represents a measure of skill or competence. In a non-limiting example, advantage cluster 152 may represent a function a system is more skilled at than another system or than an average system. In some embodiments, advantage cluster 152 may represent an attribute that is particularly important to a system's success in a target process. In a non-limiting example, an attribute cluster representing skill with certain computer programs may be an advantage cluster if a related impact metric suggests that it plays a much more important role in a system's success than other systems with attribute clusters representing skill with those computer programs. In another non-limiting example, an attribute cluster representing fluency in a certain language may be an advantage cluster relative to a population of systems in the same industry if the system does substantial work in a geography that primarily speaks that language, but the others do not. As used herein, an “impact metric” is a measure of the degree to which an attribute cluster supports a target process. In some embodiments, processor 104 may determine impact metric using an impact metric machine learning model. In some embodiments, impact metric machine learning model may be trained on data sets including historical attribute clusters, and historical target processes, associated with ratings of the degree to which historical attribute clusters support the historical target processes. Such ratings may be obtained, in a non-limiting example, from average ratings of experts as to the degree to which these historical attribute clusters supported these historical target processes. Impact metric machine learning model may accept as inputs second system attribute cluster and target process and may output impact metric.

Still referring to FIG. 1, in some embodiments, processor 104 may determine advantage cluster 152 as a function of impact metric. In some embodiments, processor 104 may use impact metric machine learning model to determine an impact metric associated with a set of attribute clusters 116. In some embodiments, processor 104 may determine advantage cluster 152 to include second system attribute cluster associated with impact metric that indicates that the second system attribute cluster provides substantial support to target process. In some embodiments, processor 104 may determine advantage cluster 152 to include second system attribute cluster associated with impact metric that indicates that the second system attribute cluster supports target process more than other attribute clusters 116. In some embodiments, processor 104 may determine advantage cluster 152 to include second system attribute cluster associated with impact metric that indicates that the second system attribute cluster supports target process more than an attribute cluster representing the population average would. In a non-limiting example, second system attribute cluster may represent a number of attributes associated with skill with certain computer programs, and processor 104 may determine second system attribute cluster to be an advantage cluster 152 where impact metric associated with second system attribute cluster indicates that second system attribute cluster supports target process more than an attribute cluster indicating average skill with those computer programs would. In non-limiting examples, population averages may include population averages among all systems, or a subset of systems, such as all systems in a particular industry. In some embodiments, processor 104 may determine advantage cluster 152 to include second system attribute cluster associated with impact metric that indicates that the second system attribute cluster supports target process more than an attribute cluster associated with a different system. In a non-limiting example, processor 104 may use processes described herein, with external system data, such as system data associated with a third party, in order to determine attribute clusters associated with a different system, and processor may compare attribute clusters or impact metrics with those of different systems to determine which attribute clusters 116 are advantage clusters 152.

Still referring to FIG. 1, in some embodiments, apparatus 100 may receive target process from a target process source. In some embodiments, a target process data source may include a computing device such as a smartphone, tablet, or computer, that accepts human data input.

Still referring to FIG. 1, in some embodiments, locating in plurality of second system attribute clusters advantage cluster 152 includes identifying target process, inputting target process into impact metric machine learning model, inputting second system attribute cluster into impact metric machine learning model, receiving impact metric from impact metric machine learning model, and determining advantage cluster 152 as a function of impact metric. In some embodiments, locating in plurality of attribute clusters advantage cluster 152 includes identifying external attribute clusters, inputting the external attribute clusters into impact metric machine learning model, inputting target process into impact metric machine learning model, receiving an external impact metric from the impact metric machine learning model, and determining advantage cluster 152 as a function of impact metric and the external impact metric. In some embodiments, impact metric indicates higher aptitude in the attribute cluster than the external impact metric.

Still referring to FIG. 1, in some embodiments, locating in plurality of attribute clusters advantage cluster 152 includes identifying two or more partial advantage clusters, and determining advantage cluster 152 as a function of the two or more partial advantage clusters. In a non-limiting example, neither of a first attribute cluster and a second attribute cluster may be advantage clusters individually, but the combination of those attributes together may be sufficiently rare that processor 104 may determine a combination of the two attribute clusters to be an advantage cluster. In some embodiments, locating in the plurality of attribute clusters an advantage cluster includes identifying target process, inputting target process into impact metric machine learning model 152, inputting an initial second system attribute cluster into impact metric machine learning model 152, inputting a follow up second system attribute cluster into impact metric machine learning model, receiving a first impact metric from impact metric machine learning model, receiving a second impact metric from impact metric machine learning model, and determining advantage cluster 152 as a function of first impact metric and second impact metric, wherein first impact metric is associated with initial second system attribute cluster and second impact metric is associated with follow up second system attribute cluster.

Still referring to FIG. 1, in some embodiments, processor 104 may determine advantage cluster 152 without the use of impact metric machine learning model. In some embodiments, processor may determine advantage cluster 152 as a function of the rarity of attribute clusters among a plurality of systems. As described above, processor 104 may determine attributes and attribute clusters applicable to third party systems based on external system data. Processor 104 may determine attributes and attribute clusters applicable to a set of systems, such as the set of companies in an industry. Processor 104 may then determine advantage cluster 152 for a system based on which attribute clusters are least prevalent in the set of systems. In a non-limiting example, processor 104 may determine attributes and attribute clusters for systems in the cell phone manufacturing industry with revenue above a predetermined amount. In this example, processor 104 may determine an advantage cluster 152 for one of those systems by examining which of that system's attribute clusters is least prevalent among the set of systems.

Still referring to FIG. 1, in some embodiments, processor 104 may determine advantage cluster 152 as a function of a value associated with second system attribute cluster. In some embodiments, processor 104 may determine advantage cluster 152 as a function of the degree to which second system attribute cluster is being utilized. In a non-limiting example, the degree to which an attribute cluster is being utilized may be estimated as a function of which elements of system data discuss the attribute cluster. In a non-limiting example, a system may have a first attribute cluster associated with employees of that system being fluent in English, and a system may have a second attribute cluster associated with employees of that system being fluent in French. In this example, if internal system documents discuss fluent in English, but employee social media accounts include posts indicating fluency in French, then this may be an indication that their fluency in French is being utilized less, and processor 104 may determine the attribute cluster associated with fluency in French to be advantage cluster 152 as a result. In another non-limiting example, the degree to which second system attribute cluster is being utilized may be estimated as a function of which internal communications discuss second system attribute cluster. In a non-limiting example, if internal communications involving manager-level employees rarely discuss second system attribute cluster, then manager-level employees may not be considering second system attribute cluster when making decisions, meaning second system attribute cluster may be utilized less than other attribute clusters that are being discussed by manager-level employees more frequently. In this example, processor 104 may determine second system attribute cluster to be advantage cluster 152 as a result of a low estimate of second system attribute cluster's utilization. In some embodiments, which documents and/or communications discuss attribute and/or second system attribute cluster may be determined, for example, using a language model as described above.

Still referring to FIG. 1, in some embodiments, processor 104 may determine advantage cluster 152 as a function of a comparison values associated with third parties having similar attribute clusters to second system attribute cluster. In a non-limiting example, processor 104 may determine attribute clusters for a set of systems, such as systems in an industry. In this example, processor 104 may determine an estimate of the size of each system in the set, such as using the revenue of a system to estimate its size. In this example, processor 104 may determine the second system attribute cluster that is shared between systems with the lowest total revenue to be advantage cluster 152.

Still referring to FIG. 1, in some embodiments, apparatus 100 may determine advantage cluster applicability 156 as a function of advantage cluster 152 and first system data 124. In some embodiments, apparatus 100 may include at least a processor 104 and memory 108 communicatively connected to the at least processor 104, the memory 108 containing instructions 112 configuring the at least processor 104 to determine advantage cluster applicability 156 as a function of advantage cluster 152 and first system data 124.

Still referring to FIG. 1, in some embodiments, determining advantage cluster applicability may include determining the degree to which the advantage cluster is applicable to the work to be done for first system. In some embodiments, determining the degree to which the advantage cluster is applicable to the work to be done for first system may be done using a language model trained to determine the degree to which words are associated based on how frequently they appear together in language. Such language models are disclosed in the description of language models above. In some embodiments, words associated with advantage cluster and words associated with first system or work to be done for first system may be input into such a language model. In some embodiments, a measure of the degree of association between the groups of words may be received as an output from such a language model. In some embodiments, advantage cluster applicability may be determined based on the degree of association between words associated with advantage cluster and words associated with first system or work to be done for first system.

Still referring to FIG. 1, in some embodiments, apparatus 100 may determine compatibility datum 160 as a function of first system target convergence 144 and advantage cluster applicability 156. In some embodiments, apparatus 100 may include at least a processor 104 and memory 108 communicatively connected to the at least processor 104, the memory 108 containing instructions 112 configuring the at least processor 104 to determine compatibility datum 160 as a function of first system target convergence 144 and advantage cluster applicability 156.

Still referring to FIG. 1, as used herein, a “compatibility datum” is a measure of the compatibility between first system and second system or the desirability of first system as a client for second system. In some embodiments, compatibility datum 160 may be determined by comparing first system target convergence 144 and advantage cluster applicability 156 to threshold values. In a non-limiting example, if first system target convergence 144 and advantage cluster applicability 156 are sufficiently high, then compatibility datum 160 may be determined such that second system may select first system as a client (for example because this may indicate that first system is a desirable client for second system and that second system's talents are a good match for first system). In some embodiments, compatibility datum 160 may be determined based on another function of first system target convergence 144 and advantage cluster applicability 156 such as a weighted sum. In some embodiments, compatibility datum 160 may be selected such that first system becomes a client of second system if the target convergence of first client is high and the advantage cluster of second system is applicable to first system. In some embodiments, processor 104 may determine compatibility datum 160 and display it to a user using a visual element data structure as described below. In some embodiments, processor 104 may determine first system target convergence 144 and advantage cluster applicability 156 and display them to a user using a visual element data structure as described below.

Still referring to FIG. 1, in some embodiments, apparatus 100 may transmit a visual element data structure to a user device. In some embodiments, apparatus 100 may include at least a processor 104 and memory 108 communicatively connected to the at least processor 104, the memory 108 containing instructions 112 configuring the at least processor 104 to transmit a visual element data structure to a user device.

Still referring to FIG. 1, in some embodiments, a visual element data structure may include a visual element. In some embodiments, a visual element data structure may include a rule for displaying visual element. In some embodiments, a visual element data structure may be determined as a function of compatibility datum 160. In some embodiments, a visual element data structure may be determined as a function of an item from the list consisting of target convergence attribute 116, first system data 124, second system data 132, high target convergence attribute pattern 140, first system target convergence 144, second system attribute cluster 148, advantage cluster 152, advantage cluster applicability 156, and compatibility datum 160. In a non-limiting example, a visual element data structure may be generated such that visual element describing or highlighting compatibility datum 160 is displayed to a user. As non-limiting examples, a visual element may depict elements of first system data that were used to determine first system target convergence and where they originated from, a comparison between first system target convergence and similar metrics calculated for previous systems, how advantage cluster applicability changed in comparison to a previous calculation for the same first and second systems, and the like.

Still referring to FIG. 1, in some embodiments, visual element may include one or more elements of text, images, shapes, charts, particle effects, interactable features, and the like. As non-limiting examples, a visual element may include charts comparing first system target convergence to similar measurements of other systems, highlighting effects applied to compatibility datum 160, and images of first system data such as logos.

Still referring to FIG. 1, a visual element data structure may include rules governing if or when visual element is displayed. In a non-limiting example, a visual element data structure may include a rule causing a visual element describing compatibility datum 160 to be displayed when a user selects compatibility datum 160 using a GUI.

Still referring to FIG. 1, a visual element data structure may include rules for presenting more than one visual element, or more than one visual element at a time. In an embodiment, about 1, 2, 3, 4, 5, 10, 20, or 50 visual elements are displayed simultaneously.

Still referring to FIG. 1, a visual element data structure rule may apply to a single visual element or datum, or to more than one visual element or datum. A visual element data structure may categorize data into one or more categories and may apply a rule to all data in a category, to all data in an intersection of categories, or all data in a subsection of a category (such as all data in a first category and not in a second category). For example, first system data may be colored green and second system data may be colored blue. A visual element data structure may rank data or assign numerical values to them. For example, if advantage cluster applicability is high, then this may be represented on a numerical scale. A numerical value may, for example, measure the degree to which a first datum is associated with a category or with a second datum. For example, the degree to which an attribute is associated with an attribute cluster may be measured and represented. A visual element data structure may apply rules based on a comparison between a ranking or numerical value and a threshold. For example, a visual element may compare first system target convergence to a threshold. Rankings, numerical values, categories, and the like may be used to set visual element data structure rules. Similarly, rankings, numerical values, categories, and the like may be applied to visual elements, and visual elements may be applied based on them. For example, 2 visual elements may compete in that they may be assigned different priorities based on the variables described herein and the one determined to be more relevant or important may be displayed.

Still referring to FIG. 1, in some embodiments, visual element may be interacted with. For example, visual element may include an interface, such as a button or menu. In some embodiments, visual element may be interacted with using a user device such as a smartphone.

Still referring to FIG. 1, in some embodiments, apparatus 100 may determine visual element. In some embodiments, apparatus 100 may include at least a processor 104 and a memory 108 communicatively connected to the at least processor 104, the memory 108 containing instructions 112 configuring the at least processor 104 to determine visual element.

Still referring to FIG. 1, in some embodiments, apparatus 100 may display visual element to user. In some embodiments, apparatus 100 may include at least a processor 104 and a memory 108 communicatively connected to the at least processor 104, the memory 108 containing instructions 112 configuring the at least processor 104 to display visual element to user.

Still referring to FIG. 1, in some embodiments, apparatus 100 may transmit visual element to a display. A display may communicate visual element to user. A display may include, for example, a smartphone screen, a computer screen, or a tablet screen. A display may be configured to provide a visual interface. A visual interface may include one or more virtual interactive elements such as, without limitation, buttons, menus, and the like. A display may include one or more physical interactive elements, such as buttons, a computer mouse, or a touchscreen, that allow user to input data into the display. Interactive elements may be configured to enable interaction between a user and a computing device. In some embodiments, a visual element data structure is determined as a function of data input by user into a display.

Still referring to FIG. 1, a variable may be represented as a data structure. In some embodiments, a data structure may include one or more functions and/or variables, as a class might in object-oriented programming. In some embodiments, a data structure may include data in the form of a Boolean, integer, float, string, date, and the like. In a non-limiting example, a first system data structure may include a string value representing a sequence of text. In some embodiments, data in a data structure may be organized in a linked list, tree, array, matrix, tenser, and the like. In a non-limiting example, elements of first system data may be organized in a linked list. In some embodiments, a data structure may include or be associated with one or more elements of metadata. A data structure may include one or more self-referencing data elements, which processor 104 may use in interpreting the data structure. In a non-limiting example, a data structure may include “<date>” and “</date>,” tags, indicating that the content between the tags is a date.

Still referring to FIG. 1, a data structure may be stored in, for example, memory 108 or a database. Database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

Still referring to FIG. 1, in some embodiments, a data structure may be read and/or manipulated by processor 104. In a non-limiting example, a first system data structure may be read and modified to a different form, such as by inputting an audio file into an automatic speech recognition algorithm and receiving a text file as an output. In another example, a first system data structure may be read and used to calculate a datum, such as the system's revenue, corresponding to a target convergence attribute, such as revenue.

Still referring to FIG. 1, in some embodiments, a data structure may be calibrated. In some embodiments, a data structure may be trained using a machine learning algorithm. In a non-limiting example, a data structure may include an array of data representing the biases of connections of a neural network. In this example, the neural network may be trained on a set of training data, and a back propagation algorithm may be used to modify the data in the array. Machine learning models and neural networks are described further herein.

Still referring to FIG. 1, in some embodiments, a visual element data structure may be determined and transmitted to a user device. In some embodiments, a visual element data structure may configure a user device to display a visual element to a user, wherein the visual element depicts a comparison between the compatibility datum and a threshold value.

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm instantiated in hardware or software logic, data structures, and/or functions that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example, inputs may include speech data and an output may include a text transcript of the speech data.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data to filter based on the importance of attributes related to target convergence. If certain attributes are known to significantly influence target convergence, they should be prioritized in the dataset. This ensures that the machine learning model is being trained with data that is most relevant to the problem at hand. Reducing the dimensionality of the data in this way helps to prevent overfitting and can improve the efficiency and accuracy of the machine-learning model.

With further reference to FIG. 2, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Still referring to FIG. 2, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may identified as having poor quality data, where “poor quality” is defined as having a signal to noise ratio below a threshold value.

As a non-limiting example, and with further reference to FIG. 2, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 2, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units

In some embodiments, and with continued reference to FIG. 2, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include an audio file as described above as inputs, a text file as outputs and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With further reference to FIG. 2, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 2, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 2, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 2, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 2, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 2, one or more processes or algorithms described above may be performed by at least a dedicated hardware unit 232. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 232 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 232 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 232 to perform one or more operations described herein, such as evaluation of model and/or algorithm outputs, one-time or iterative updates to parameters, coefficients, weights, and/or biases, and/or any other operations such as vector and/or matrix operations as described in this disclosure.

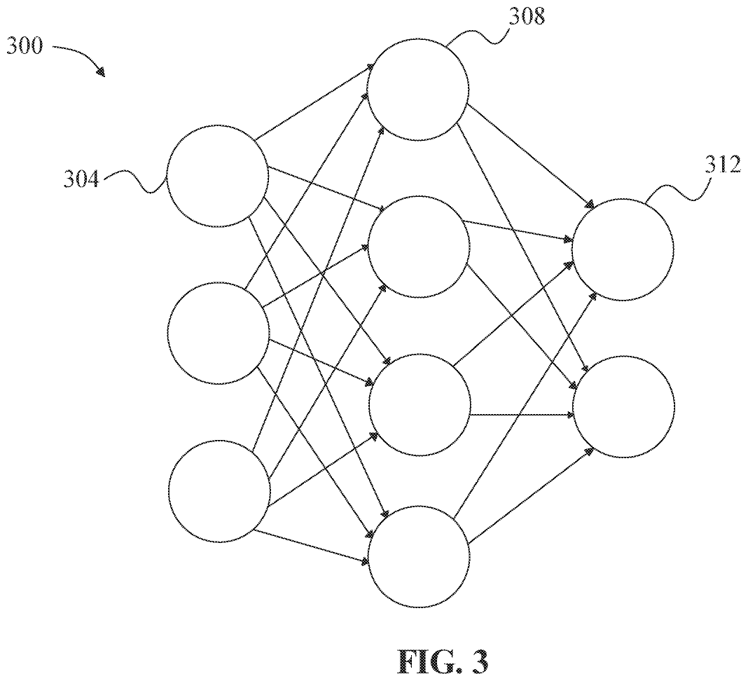

Referring now to FIG. 3, an exemplary embodiment of neural network 300 is illustrated. A neural network 300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

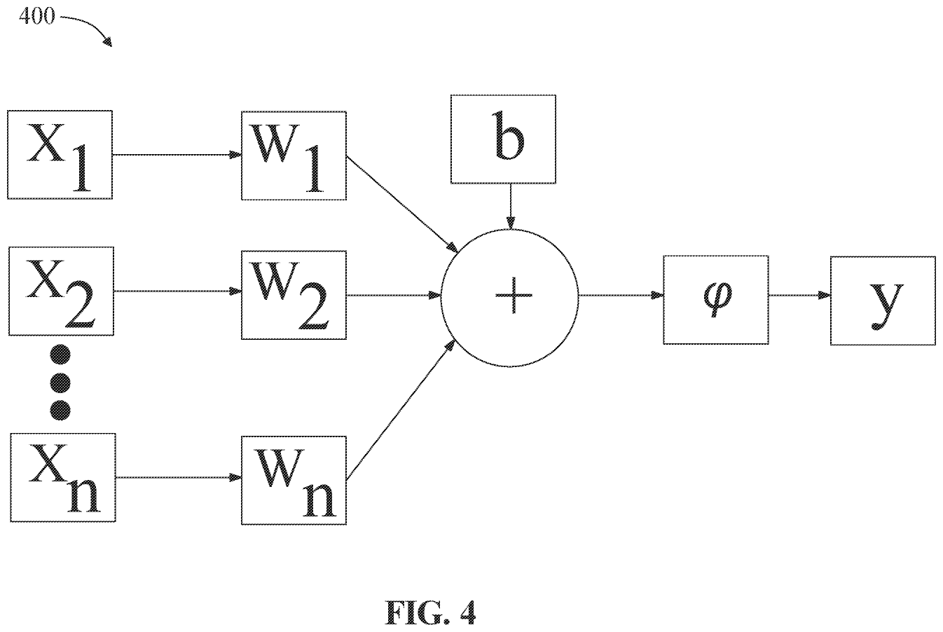

Referring now to FIG. 4, an exemplary embodiment of a node 400 of a neural network is illustrated. A node may include, without limitation, a plurality of inputs xi that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as f(x)=tanh²(x), a rectified linear unit function such as f(x)=max(0, x), a “leaky” and/or “parametric” rectified linear unit function such as f(x)=max(ax, x) for some a, an exponential linear units function such as

$$f ( x ) = \{ \begin{matrix}x for x \geq 0 \\ α ( {e}^{x} - 1 ) for x < 0\end{matrix}$$

for some value of a (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as f(x)=x*sigmoid(x), a Gaussian error linear unit function such as f(x)=a(1+tanh(\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xi that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

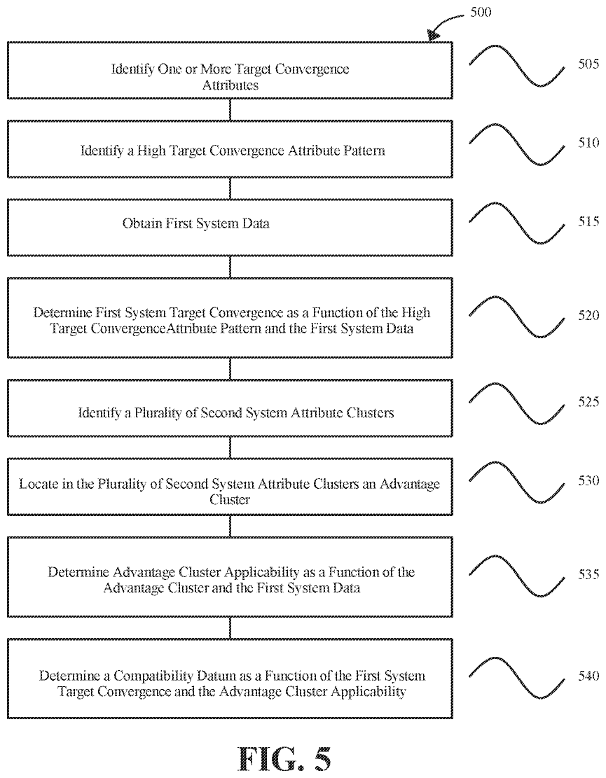

Now referring to FIG. 5, an exemplary embodiment of a method 500 of data structure generation is illustrated.

Still referring to FIG. 5, in some embodiments, method 500 may include identifying one or more target convergence attributes 505; this may be implemented, without limitation, as described above with reference to FIG. 1. In some embodiments, identifying one or more target convergence attributes includes identifying a target convergence attribute data set, wherein the target convergence attribute data set comprises a plurality of data points, the plurality of data points including ratings on a plurality of test attributes; and target values; and identifying one or more target convergence attributes as a function of the target convergence attribute data set. In some embodiments, identifying one or more target convergence attributes as a function of target convergence attribute data set includes identifying the test attributes whose degree of correlation with target value is above a threshold.

Still referring to FIG. 5, in some embodiments, method 500 may include identifying a high target convergence attribute pattern 510; this may be implemented, without limitation, as described above with reference to FIG. 1. In some embodiments, identifying a high target convergence attribute pattern includes training an attribute pattern machine learning model using a supervised learning algorithm.

Still referring to FIG. 5, in some embodiments, method 500 may include obtaining first system data 515; this may be implemented, without limitation, as described above with reference to FIG. 1.

Still referring to FIG. 5, in some embodiments, method 500 may include determining first system target convergence as a function of high target convergence attribute pattern and first system data 520; this may be implemented, without limitation, as described above with reference to FIG. 1. In some embodiments, determining first system target convergence may include inputting first system data into the attribute pattern machine learning model; and receiving first system target convergence from the attribute pattern machine learning model.

Still referring to FIG. 5, in some embodiments, method 500 may include identifying a plurality of second system attribute clusters 525; this may be implemented, without limitation, as described above with reference to FIG. 1. In some embodiments, identifying a plurality of second system attribute clusters may include identifying second system data; inputting second system data into an attribute classifier; and receiving a plurality of second system attributes from the attribute classifier. In some embodiments, identifying a plurality of attribute clusters may include inputting a plurality of second system attributes into a clustering algorithm; and receiving a plurality of second system attribute clusters from the clustering algorithm.

Still referring to FIG. 5, in some embodiments, method 500 may include locating in the plurality of second system attribute clusters an advantage cluster 530; this may be implemented, without limitation, as described above with reference to FIG. 1. In some embodiments, locating in the plurality of second system attribute clusters an advantage cluster may include identifying a target process; inputting the target process into an impact metric machine learning model; inputting a second system attribute cluster into an impact metric machine learning model; receiving an impact metric from the impact metric machine learning model; and determining an advantage cluster as a function of an impact metric.

Still referring to FIG. 5, in some embodiments, method 500 may include determining advantage cluster applicability as a function of the advantage cluster and the first system data 535; this may be implemented, without limitation, as described above with reference to FIG. 1.

Still referring to FIG. 5, in some embodiments, method 500 may include determining a compatibility datum as a function of the first system target convergence and the advantage cluster applicability 540; this may be implemented, without limitation, as described above with reference to FIG. 1.

Still referring to FIG. 5, in some embodiments, method 500 may further include determining a visual element data structure as a function of the compatibility datum; and transmitting the visual element data structure to a user device. In some embodiments, visual element data structure configures the user device to display a visual element to a user, wherein the visual element depicts a comparison between the compatibility datum and a threshold value. In some embodiments, one or more steps of method 500 may be done using at least a processor.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

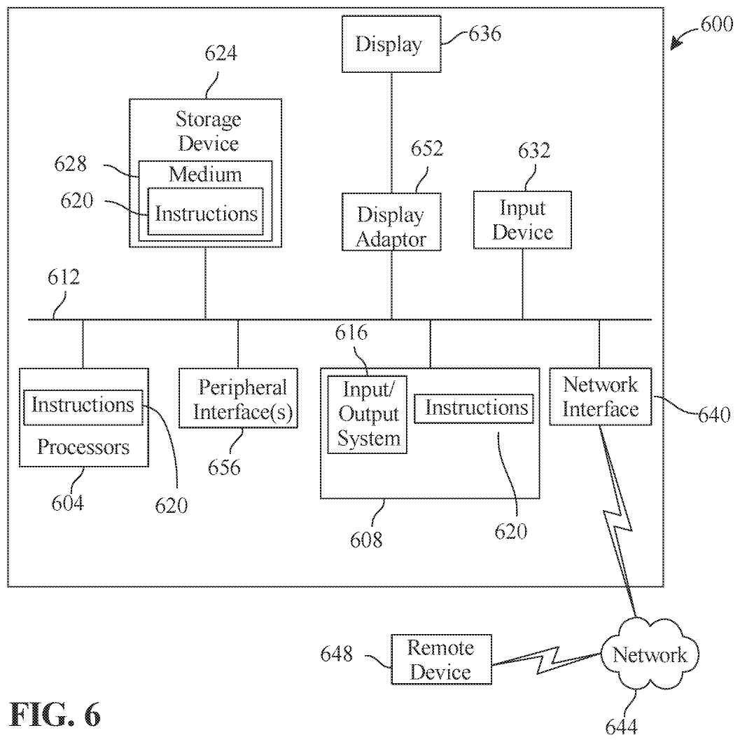

FIG. 6 shows a diagrammatic representation of one embodiment of a computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 604 and a memory 608 that communicate with each other, and with other components, via a bus 612. Bus 612 may include any of several types of bus structures including, but not limited to, a memory bus, a memory controller, a peripheral bus, a local bus, and any combinations thereof, using any of a variety of bus architectures.

Processor 604 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 604 may be organized according to Von Neumann and/or Harvard architecture as a non-limiting example. Processor 604 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 608 may include various components (e.g., machine-readable media) including, but not limited to, a random-access memory component, a read only component, and any combinations thereof. In one example, a basic input/output system 616 (BIOS), including basic routines that help to transfer information between elements within computer system 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating system, one or more application programs, other program modules, program data, and any combinations thereof.

Computer system 600 may also include a storage device 624. Examples of a storage device (e.g., storage device 624) include, but are not limited to, a hard disk drive, a magnetic disk drive, an optical disc drive in combination with an optical medium, a solid-state memory device, and any combinations thereof. Storage device 624 may be connected to bus 612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 624 (or one or more components thereof) may be removably interfaced with computer system 600 (e.g., via an external port connector (not shown)). Particularly, storage device 624 and an associated machine-readable medium 628 may provide nonvolatile and/or volatile storage of machine-readable instructions, data structures, program modules, and/or other data for computer system 600. In one example, software 620 may reside, completely or partially, within machine-readable medium 628. In another example, software 620 may reside, completely or partially, within processor 604.

Computer system 600 may also include an input device 632. In one example, a user of computer system 600 may enter commands and/or other information into computer system 600 via input device 632. Examples of an input device 632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 632 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 632 may include a touch screen interface that may be a part of or separate from display 636, discussed further below. Input device 632 may be utilized as a user selection device for selecting one or more graphical representations in a graphical interface as described above.

A user may also input commands and/or other information to computer system 600 via storage device 624 (e.g., a removable disk drive, a flash drive, etc.) and/or network interface device 640. A network interface device, such as network interface device 640, may be utilized for connecting computer system 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer system 600 via network interface device 640.

Computer system 600 may further include a video display adapter 652 for communicating a displayable image to a display device, such as display device 636. Examples of a display device include, but are not limited to, a liquid crystal display (LCD), a cathode ray tube (CRT), a plasma display, a light emitting diode (LED) display, and any combinations thereof. Display adapter 652 and display device 636 may be utilized in combination with processor 604 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for data structure generation to determine a compatibility datum, the apparatus comprising:
at least one processor; and
a memory communicatively connected to the at least one processor, the memory containing instructions configuring the at least one processor to:
identify one or more target convergence attributes, wherein identifying the one or more target convergence attributes comprises:
identifying a target convergence attribute data set, wherein the target convergence attribute data set comprises a plurality of data points, the plurality of data points comprising:
ratings on a plurality of test attributes; and
target values related to desirability reflecting interaction dynamics and transactional efficiency; and
identifying the one or more target convergence attributes as a function of the target convergence attribute data set;
identify a high target convergence attribute pattern, wherein identifying the high target convergence attribute pattern comprises:
iteratively training an attribute pattern machine learning model using training data configured to correlate system data inputs to target convergence attribute outputs;
obtain first system data wherein the first system data is obtained from a first system data source, wherein the first system data comprises data in image format;
process the first system data, using a machine vision system to extract textual data from the image format, wherein processing the first system data comprises pre-processing at least an image in the image format using a de-skew process;
determine first system target convergence as a function of the high target convergence attribute pattern and the first system data;
identify a plurality of second system attribute clusters;
locate in the plurality of second system attribute clusters an advantage cluster;
determine advantage cluster applicability as a function of the advantage cluster and the first system data; and
determine a compatibility datum as a function of the first system target convergence and the advantage cluster applicability.

2. (canceled)

3. The apparatus of claim 1, wherein identifying the one or more target convergence attributes as a function of the target convergence attribute data set comprises identifying the test attributes whose degree of correlation with a target value is above a threshold.

4. The apparatus of claim 1, wherein identifying the high target convergence attribute pattern comprises training an attribute pattern machine learning model using a supervised learning algorithm.

5. The apparatus of claim 4, wherein determining the first system target convergence comprises:
inputting the first system data into the attribute pattern machine learning model; and
receiving the first system target convergence from the attribute pattern machine learning model.

6. The apparatus of claim 1, wherein identifying the plurality of second system attribute clusters comprises:
identifying second system data;
inputting the second system data into an attribute classifier; and
receiving a plurality of second system attributes from the attribute classifier.

7. The apparatus of claim 6, wherein identifying the plurality of second system attribute clusters comprises:
inputting the plurality of second system attributes into a clustering algorithm; and
receiving a plurality of second system attribute clusters from the clustering algorithm.

8. The apparatus of claim 1, wherein locating in the plurality of second system attribute clusters the advantage cluster comprises:
identifying a target process;
inputting the target process into an impact metric machine learning model;
inputting a second system attribute cluster into the impact metric machine learning model;
receiving an impact metric from the impact metric machine learning model; and
determining the advantage cluster as a function of the impact metric.

9. The apparatus of claim 1, wherein the memory contains instructions configuring the at least one processor to:
determine a visual element data structure as a function of the compatibility datum; and
transmit the visual element data structure to a user device.

10. The apparatus of claim 9, wherein the visual element data structure configures the user device to display a visual element to a user.

11. A method of data structure generation to determine a target compatibility datum, the method comprising:
identifying, by at least one processor, one or more target convergence attributes, wherein
identifying the one or more target convergence attributes comprises:
identifying a target convergence attribute data set, wherein the target convergence attribute data set comprises a plurality of data points, the plurality of data points comprising:
ratings on a plurality of test attributes; and
target values related to desirability reflecting interaction dynamics and transactional efficiency; and
identifying the one or more target convergence attributes as a function of the target convergence attribute data set;
identifying, by the at least one processor, a high target convergence attribute pattern, wherein identifying the high target convergence attribute pattern comprises:
iteratively training an attribute pattern machine learning model using training data configured to correlate system data inputs to target convergence attribute outputs;
obtaining, by the at least one processor, first system data, wherein the first system data is obtained from a first system data source, wherein the first system data comprises data in image format;
processing, by the at least one processor, the first system data, using a machine vision system to extract textual data from the image format, wherein processing the first system data comprises pre-processing at least an image in the image format using a de-skew process;
determining, by the at least one processor, first system target convergence as a function of the high target convergence attribute pattern and the first system data;
identifying, by the at least one processor, a plurality of second system attribute clusters;
locating, by the at least one processor, in the plurality of second system attribute clusters an advantage cluster;
determining, by the at least one processor, advantage cluster applicability as a function of the advantage cluster and the first system data; and
determining, by the at least one processor, a compatibility datum as a function of the first system target convergence and the advantage cluster applicability.

12. (canceled)

13. The method of claim 11, wherein identifying the one or more target convergence attributes as a function of the target convergence attribute data set comprises identifying, by the at least one processor, the test attributes whose degree of correlation with target value is above a threshold.

14. The method of claim 11, wherein identifying the high target convergence attribute pattern comprises training, by the at least one processor, an attribute pattern machine learning model using a supervised learning algorithm.

15. The method of claim 14, wherein determining the first system target convergence comprises:
inputting, by the at least one processor, the first system data into the attribute pattern machine learning model; and
receiving, by the at least one processor, the first system target convergence from the attribute pattern machine learning model.

16. The method of claim 11, wherein identifying the plurality of second system attribute clusters comprises:
identifying, by the at least one processor, second system data;
inputting, by the at least one processor, the second system data into an attribute classifier; and
receiving, by the at least one processor, a plurality of second system attributes from the attribute classifier.

17. The method of claim 16, wherein identifying the plurality of second system attribute clusters comprises:
inputting, by the at least one processor, the plurality of second system attributes into a clustering algorithm; and
receiving, by the at least one processor, a plurality of second system attribute clusters from the clustering algorithm.

18. The method of claim 11, wherein locating in the plurality of second system attribute clusters the advantage cluster comprises:
identifying, by the at least one processor, a target process;
inputting, by the at least one processor, the target process into an impact metric machine learning model;
inputting, by the at least one processor, a second system attribute cluster into the impact metric machine learning model;
receiving, by the at least one processor, an impact metric from the impact metric machine learning model; and
determining, by the at least one processor, the advantage cluster as a function of the impact metric.

19. The method of claim 11, further comprising:
determining, by the at least one processor, a visual element data structure as a function of the compatibility datum; and
transmitting, by the at least one processor, the visual element data structure to a user device.

20. The method of claim 19, wherein the visual element data structure configures the user device to display a visual element to a user.
